(19) United States
(12) Patent Application Publication
(10) Pub. No.: US 2024/0028074 A1
(43) Pub. Date: Jan. 25, 2024

(54) VR GLASSES HEADBAND

(71) Applicant: SHENZHEN XINLIANYOUPIN TECHNOLOGY CO., LIMITED, Shenzhen (CN)

(72) Inventor: Jinxin GU, Shenzhen (CN)

(73) Assignee: SHENZHEN XINLIANYOUPIN TECHNOLOGY CO., LIMITED, Shenzhen (CN)

(21) Appl. No.: 18/323,359

(22) Filed: May 24, 2023

(30) Foreign Application Priority Data
Jul. 19, 2022 (CN) 202221877207.3
Jul. 19, 2022 (CN) 202221880857.3

(51) Int. Cl. G06F 1/16; H02G 11/02; H04R 1/10; A42B 7/00

(52) U.S. Cl. CPC G06F 1/163; H02G 11/02; H04R 1/1041; H04R 1/1008; H04R 1/1033; H04R 1/105; H04R 1/1058; A42B 7/00; H04R 2499/15

(57) ABSTRACT

A VR glasses headband includes a glasses body and a headband body connected with each other. The headband body comprises a first binding strap and a second binding strap; the first binding strap is used for abutting against the back side of a head of a human body, the second binding strap is used for abutting against the top of the head of a human body, the second binding strap is rotatably connected to the first binding strap, the first binding strap is provided with a first adjustment structure for adjusting the length of the first binding strap, and the second binding strap is provided with a second adjustment structure for adjusting the length of the second binding strap; the VR glasses headband provided by the present application has the feature of good wearing comfort, adapting to the wearing requirements of people with different head sizes, and improving wearing comfort.

### CROSS-REFERENCE TO RELATED APPLICATIONS

This application claims priority to Chinese Patent Application No. 202221880857.3, filed on Jul. 19, 2022, and Chinese Patent Application No. 202221877207.3, filed on Jul. 19, 2022. All of the aforementioned applications are incorporated herein by reference in their entireties.

### TECHNICAL FIELD

The present application relates to the technical field of Virtual Reality (VR) devices, in particular to a VR glasses headband.

### BACKGROUND

Virtual Reality Head Mounted Display (VR HMD) uses a head-mounted display device to close human vision and hearing to the outside world, so as to guide a user to generate a sense of being in a virtual environment. The display principle is that the left eye screen and the right eye screen respectively display images of the left eye and the right eye; after acquiring such information with differences, the human eye generates a three-dimensional sense in the brain; VR glasses can use relevant technologies in the later stage of films and television to represent the production content in a high-demand VR virtual reality scene such as relevant character actions and expressions. The specific shooting can be real characters, and combination and processing are performed by using image matting synthesis technology such that when it is integrated into VR virtual reality scene, the effect is realistic and natural, the production cost is reduced, and the working efficiency is improved.

However, the existing VR glasses provide poor comfort. As users often involve a number of people of different ages, the existing VR glasses are not easy to adjust left and right and up and down according to the size of the heads of different people, thereby providing poor comfort. Besides, it is inconvenient for the existing VR glasses to store and carry after use.

### SUMMARY

The technical problem to be solved by the present application is to provide a VR glasses headband with good comfort.

In order to solve the above technical problem, the technical solution adopted by the present application is: a VR glasses headband comprising a glasses body and a headband body connected to each other; wherein the headband body comprises a first binding strap and a second binding strap, the first binding strap is used for abutting against the back side of a head of a human body, the second binding strap is used for abutting against the top of the head of a human body, the second binding strap is rotatably connected to the first binding strap, the first binding strap is provided with a first adjustment structure for adjusting the length of the first binding strap, and the second binding strap is provided with a second adjustment structure for adjusting the length of the second binding strap.

The advantageous effect of the present application is that the present application provides a VR glasses headband with the feature of good wearing comfort; the first adjustment structure is provided to adjust the length of the first binding strap, the second adjustment structure is provided to adjust the length of the second binding strap so as to adapt to the wearing requirements of people with different head sizes, and the second binding strap is provided to be rotatably mounted to the first binding strap so as to adapt to the wearing requirements of people with different head shapes, thereby greatly improving the wearing comfort.

### BRIEF DESCRIPTION OF THE DRAWINGS

FIG. 1 is a schematic diagram of the structure of a VR glasses headband in embodiment 1 of the present application (after hiding the glasses body).

FIG. 2 is an exploded view of the VR glasses headband in embodiment 1 of the present application.

FIG. 3 is a schematic diagram of the partial cross-sectional structure of the VR glasses headband in embodiment 1 of the present application.

FIG. 4 is a schematic diagram of another partial cross-sectional structure of the VR glasses headband in embodiment 1 of the present application.

FIG. 5 is a schematic structural diagram of another perspective of the VR glasses headband in embodiment 1 of the present application (after hiding the glasses body).

FIG. 6 is a schematic diagram of a partial structure of the VR glasses headband in embodiment 1 of the present application (after hiding a housing).

FIG. 7 is an exploded view of a take-up cable for the VR glasses headband in embodiment 1 of the present application.

FIG. 8 is a schematic diagram of a partial structure of the VR glasses headband in embodiment 1 of the present application (after hiding a mounting structure).

FIG. 9 is a schematic structural diagram of a mounting structure of the VR glasses headband in embodiment 1 of the present application.

### DETAILED DESCRIPTION OF THE EMBODIMENTS

In order to explain the technical contents, the objects, and the effects of the present application in detail, the following description will be given in conjunction with the implementation modes and in conjunction with the accompanying drawings.

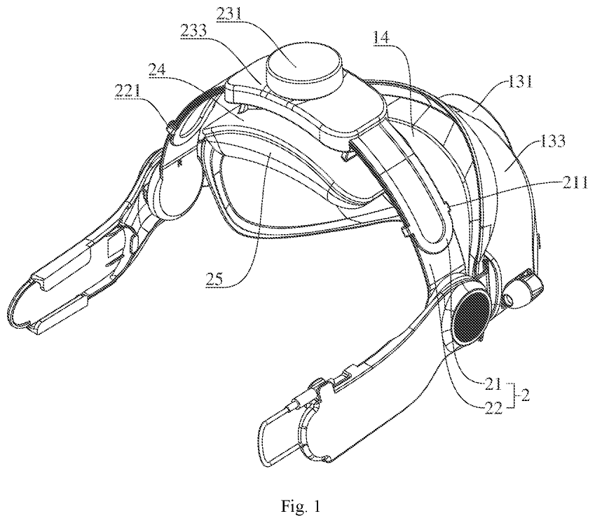

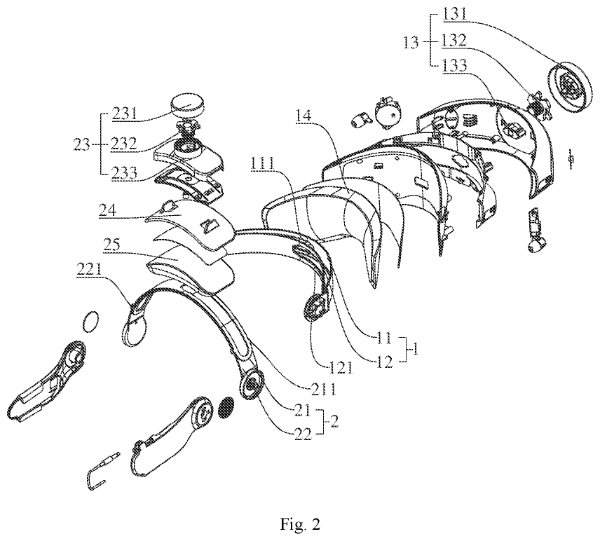

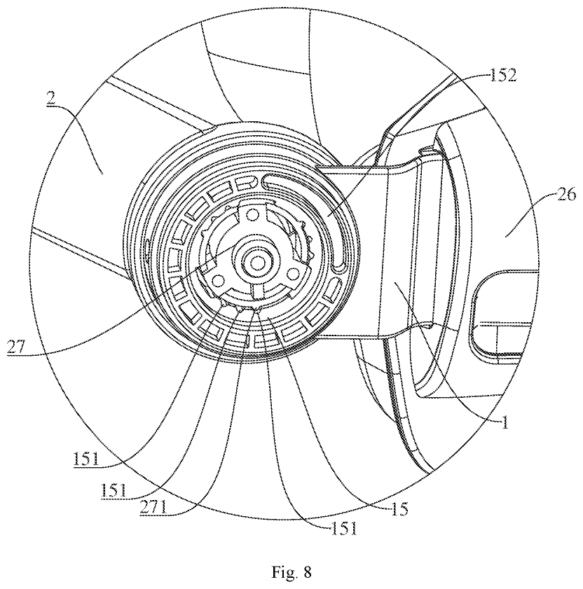

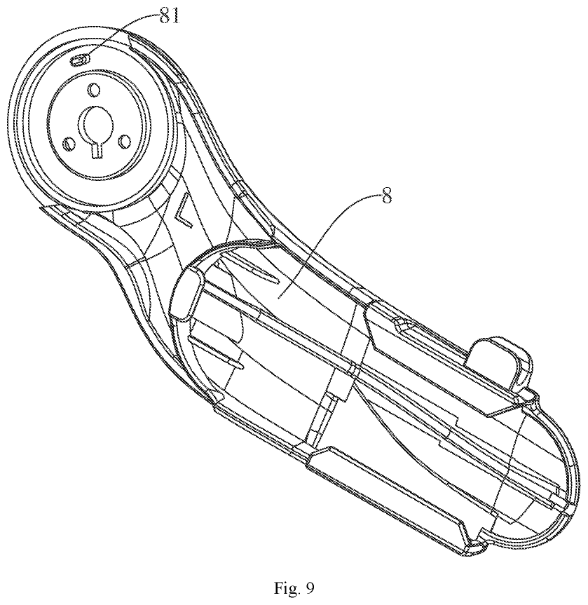

Referring to FIGS. 1-9, a VR glasses headband includes a glasses body connected to a headband body. The headband body includes a first binding strap 1 and a second binding strap 2, the first binding strap 1 is used for abutting against the back side of a head of a human body, the second binding strap 2 is used for abutting against the top of the head of a human body, the second binding strap 2 is rotatably connected to the first binding strap 1, the first binding strap 1 is provided with a first adjustment structure 13 for adjusting the length of the first binding strap 1, and the second binding strap 2 is provided with a second adjustment structure 23 for adjusting the length of the second binding strap 2.

It can be known from the above description, the present application has an advantageous effect that: the first adjustment structure 13 is provided to adjust the length of the first binding strap 1, the second adjustment structure 23 is provided to adjust the length of the second binding strap 2 so as to adapt to the wearing requirements of people with different head sizes, and the second binding strap 2 is provided to be rotatably mounted to the first binding strap 1 so as to adapt to the wearing requirements of people with different head shapes, thereby greatly improving comfort.

Further, the second binding strap 2 is provided with an overhead cushion pad 25 for contact with the top of the human head.

It can be seen from the above description that the overhead cushion pad 25 can cushion the pressure of the second binding strap 2 acting on the top of the human head, so as to improve the comfort of the VR glasses headband.

Further, the second binding strap 2 is provided with a mounting bracket 24 to which the overhead cushion pad 25 is mounted.

As can be seen from the above description, the mounting bracket 24 facilitates the mounting of the overhead cushion pad 25.

Further, the material of the overhead cushion pad 25 is flexible.

It can be seen from the above description that the material of the overhead cushion pad 25 can be selected according to actual application requirements.

Further, the first binding strap 1 comprises a first adjustment strap 11 and a second adjustment strap 12 rotatably connected to the second binding strap 2 respectively. The first adjustment strap 11 is provided with a first rack 111 extending along the length direction thereof, and the second adjustment strap 12 is provided with a second rack 121 extending along the length direction thereof; the first adjustment structure 13 comprises a first mounting seat 133, a first adjustment gear 132, and a first adjustment knob 131; the first adjustment strap 11 and the second adjustment strap 12 are slidably mounted to the first mounting seat 133. The first adjustment knob 131 is rotatably connected to the first mounting seat 133, the first adjustment gear 132 is mounted to the first adjustment knob 131, the first rack 111 is engaged with one side of the first adjustment gear 132, and the second rack 121 is engaged with the other side of the first adjustment gear 132.

It can be seen from the above-mentioned description that the first adjustment knob 131 is used for driving the first adjustment gear 132 to rotate, and by changing the meshing stroke between the first adjustment gear 132 and the first rack 111 and the second rack 121, the first adjustment strap 11 and the second adjustment strap 12 move along the respective length directions, thereby changing the overall length of the first binding strap 1, with high accuracy of adjustment, and further improving the adaptability of the present VR glasses headband.

Further, the second binding strap 2 comprises a third adjustment strap 21 and a fourth adjustment strap 22 respectively rotatably connected to the first binding strap 1, the third adjustment strap 21 is provided with a third rack 212 extending along the length direction thereof, the fourth adjustment strap 22 is provided with a fourth rack 222 extending along the length direction thereof, the second adjustment structure 23 comprises a second mounting seat 233, a second adjustment gear 232, and a second adjustment knob 231, and the third adjustment strap 21 and the fourth adjustment strap 22 are slidably mounted to the second mounting seat 233. The second adjustment knob 231 is rotatably connected to the second mounting seat 233, the second adjustment gear 232 is mounted to the second adjustment knob 231, the third rack gear 212 is engaged with one side of the second adjustment gear 232, and the fourth rack 222 is engaged with the other side of the second adjustment gear 232.

It can be seen from the above-mentioned description that the second adjustment knob 231 is used for driving the second adjustment gear 232 to rotate, and by changing the meshing stroke between the second adjustment gear 232 and the third rack 212 and the fourth rack 222, the third adjustment strap 21 and the fourth adjustment strap 22 move along the respective length directions, thereby changing the overall length of the second binding strap 2, with high adjustment accuracy, and further improving the adaptability of the present VR glasses headband.

Further, the third adjustment strap 21 is provided with a first snap-fit 211, which snaps onto the fourth adjustment strap 22.

As can be seen from the above description, the first snap-fit 211 facilitates the abutment of the third adjustment strap 21 against the fourth adjustment strap 22, reducing the risk of the third adjustment strap 21 loosening and turning up.

Further, the fourth adjustment strap 22 is provided with a second snap-fit 221, which snaps onto the third adjustment strap 21.

It can be seen from the above description that the second snap-fit 221 facilitates the abutment of the fourth adjustment strap 22 against the third adjustment strap 21, reducing the risk of the fourth adjustment strap 22 loosening and turning up.

Further, the first binding strap 1 is provided with a rear pillow cushion pad 14 for contact with the back side of the head of a human body.

It can be seen from the above-mentioned description that the rear pillow cushion pad 14 facilitates cushioning the pressure of the first binding strap 1 acting on the back side of the head of a human body, improving the comfort of the VR glasses headband.

Further, an earphone head 7, an earphone cable, and a take-up cable are included. The earphone head 7 is connected to one end of the earphone cable, the earphone cable is wound around the take-up device, the other end of the earphone cable is electrically connected to the glasses body, and the take-up device is mounted to the headband body.

It can be seen from the above-mentioned description that the earphone head 7 is mounted to the take-up cable via the earphone cable, and the expansion and contraction of the earphone cable are realized via the take-up cable so as to facilitate the storage and use of the earphone head; the take-up cable is provided on the headband body, so as to reduce the load of the glasses body, ease the load feeling of the eyes when the user wears it, and further improve the wearing comfort.

Further, the take-up cable comprises a take-up box, a central post 31, a take-up reel 5, and a spring 32. The central post 31 is mounted in the take-up box, the take-up reel 5 is rotatably mounted to the central post 31, and the earphone cable is wound around the take-up reel 5; one end of the spring 32 is connected to the central post 31, and the other end is connected to the take-up reel 5.

It can be seen from the above-mentioned description that the take-up box facilitates the storage of the earphone cable, and the take-up reel 5 facilitates the winding of the earphone cable; when the earphone cable extends out of the take-up box for a certain length, the take-up reel 5 automatically rotates under the action of the spring 32, thereby realizing the automatic recovery of the earphone cable and improving the convenience of using the VR glasses headband.

Further, the take-up box is further provided with a non-return structure connected to the take-up reel 5 for limiting the rotation of the take-up reel 5.

It can be seen from the above-mentioned description that the non-return structure can limit the automatic rotation of the take-up reel 5, ensuring that the earphone is not pulled during use, which is beneficial to the improvement of user experience.

Further, the take-up reel 5 is provided with a limiting portion 51, the limiting portion 51 is provided with multiple limiting grooves 52 which are evenly spaced along the central axis of the central post 31, and the non-return structure comprises a limiting snap-fit 41 which is slidably mounted to the take-up box. The limiting snap-fit 41 abuts against the limiting portion 51 for, with the limiting groove 52, limiting the rotation of the take-up reel 5.

It can be seen from the above-mentioned description that the rotation of the take-up reel can be effectively limited by the cooperation of the limiting snap-fit 41 and the limiting groove 52; when it is necessary to recover the earphone cable, only the limiting snap-fit 41 needs to be swiped to slide, so that the limiting snap-fit 41 is separated from the limiting groove 52 to realize the automatic recovery of the earphone cable, further improving the convenience of using the VR glasses headband.

Further, the non-return structure further comprises an elastic member 42 mounted to the take-up box and connected to the limiting snap-fit 41, and the elastic member 42 is used for supporting the limiting snap-fit 41 in the limiting groove 52.

It can be seen from the above-mentioned description that the elastic member 42 facilitates supporting the limiting snap-fit 41 in the limiting groove 52, ensuring that the limiting snap-fit 41 can effectively limit the rotation of the take-up reel 5, and facilitating the improvement of structural stability.

Further, a take-up button 6 mounted to the headband body is further included. The take-up button 6 abuts against the limiting snap-fit 41. When the take-up button 6 is pressed, the limiting snap-fit 41 is disengaged from the limiting groove 52.

Further, the take-up button 6 is provided with a first wedge-shaped portion, and one end of the limiting snap-fit 41 near the central post 31 is provided with a second wedge-shaped portion abutting against the first wedge-shaped portion.

It can be seen from the above-mentioned description that the take-up button 6 facilitates pushing the limiting snap-fit 41 away from the limiting groove 52, and a user merely needs to press the take-up button 6 to realize automatic recovery of the earphone cable, further improving the convenience of using the VR glasses headband.

Further, two opposite sides of the take-up button 6 are respectively provided with mounting elastic pieces 61, and the mounting elastic pieces 61 are connected to the headband body.

It can be seen from the above-mentioned description that the mounting elastic piece 61 facilitates mounting the take-up button 6 to the headband body, and the mounting elastic piece 61 can also provide a rebound force to the take-up button 6. When a user releases the take-up button 6, the take-up button 6 can automatically rebound under the action of the mounting elastic piece 61, further improving the convenience of using the VR glasses headband.

Further, the take-up reel 5 is further provided with a circuit board 53, and the circuit board 53 is electrically connected to the earphone cable.

It can be seen from the above-mentioned description that the circuit board 53 facilitates the electrical connection with the earphone cable, and ensures the stability of the power amplifier of the earphone head 7.

Further, the take-up box is further provided with a conductive elastic piece electrically connected to the glasses body, and the conductive elastic piece abuts against and is electrically connected to the circuit board 53.

It can be seen from the above-mentioned description that the conductive elastic piece facilitates the electrical connection between the circuit board 53 and the glasses body; the conductive elastic piece is mounted to the take-up box and abuts the circuit board 53; when the take-up reel 5 rotates, the conductive elastic piece does not rotate along with the circuit board 53, avoiding the phenomenon of conductive wire winding between the conductive elastic piece and the glasses body, and ensuring the stability of the functional performance of the VR glasses headband.

### Embodiment 1

With reference to FIGS. 1 to 9, embodiment 1 of the present application is: a VR glasses headband, comprising a glasses body and a headband body which are connected, and further comprising an earphone head 7, an earphone cable, and a take-up device, wherein the earphone head 7 is connected to one end of the earphone cable, the earphone cable is wound around the take-up device, the other end of the earphone cable is electrically connected to the glasses body, and the take-up device is mounted to the headband body; the headband body comprises a first binding strap 1 and a second binding strap 2, the first binding strap 1 is used for abutting against the back side of a head of a human body, the second binding strap 2 is used for abutting against the top of the head of a human body, the second binding strap 2 is rotatably connected to the first binding strap 1, the first binding strap 1 is provided with a first adjustment structure 13 for adjusting the length of the first binding strap 1, and the second binding strap 2 is provided with a second adjustment structure 23 for adjusting the length of the second binding strap 2; specifically, the first binding strap 1 is provided with a rear pillow cushion pad 14, the rear pillow cushion pad 14 is used for contacting with the back side of a head of a human body, and the rear pillow cushion pad 14 facilitates cushioning the pressure of the first binding strap 1 acting on the back side of a head of a human body, improving the comfort of the VR glasses headband.

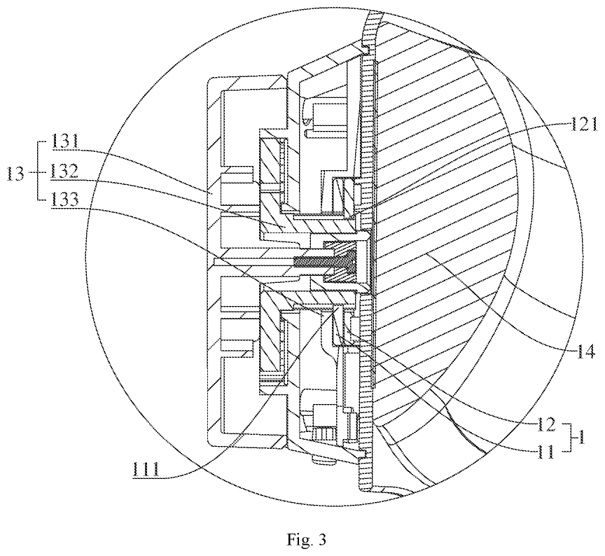

Preferably, in conjunction with FIG. 3, the first binding strap 1 comprises a first adjustment strap 11 and a second adjustment strap 12 respectively rotatably connected to the second binding strap 2, the first adjustment strap 11 is provided with a first rack 111 extending along the length direction thereof, the second adjustment strap 12 is provided with a second rack 121 extending along the length direction thereof, and the first adjustment structure 13 comprises a first mounting seat 133, a first adjustment gear 132, and a first adjustment knob 131; the first adjustment strap 11 and the second adjustment strap 12 are slidably mounted to the first mounting seat 133, the first adjustment knob 131 is rotatably connected to the first mounting seat 133, the first adjustment gear 132 is mounted to the first adjustment knob 131, the first rack 111 meshes with one side of the first adjustment gear 132, and the second rack 121 meshes with the other side of the first adjustment gear 132; it could be understood that the first adjustment knob 131 is used to drive the first adjustment gear 132 to rotate, and the first adjustment strap 11 and the second adjustment strap 12 move in the respective length directions by changing the meshing stroke between the first adjustment gear 132 and the first rack 111 and the second rack 121, thereby changing the overall length of the first binding strap 1, with high accuracy of adjustment, and further improving the adaptability of the present VR glasses headband.

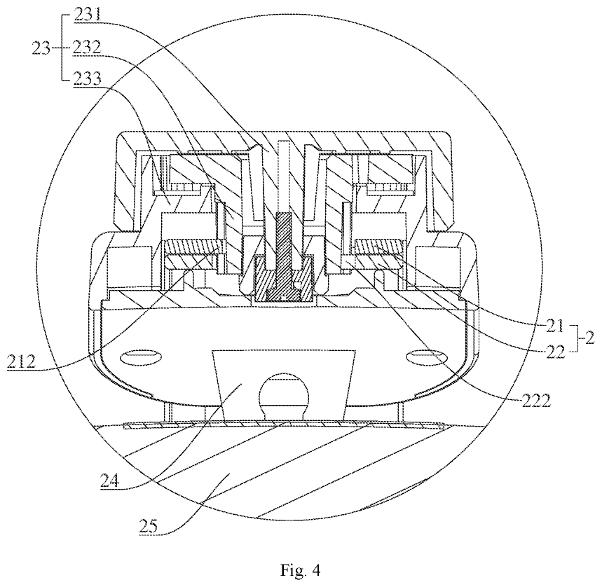

Preferably, in conjunction with FIG. 4, the second binding strap 2 comprises a third adjustment strap 21 and a fourth adjustment strap 22 respectively rotatably connected to the first binding strap 1, the third adjustment strap 21 is provided with a third rack 212 extending along the length direction thereof, the fourth adjustment strap 22 is provided with a fourth rack 222 extending along the length direction thereof, and the second adjustment structure 23 comprises a second mounting seat 233, a second adjustment gear 232, and a second adjustment knob 231; the third adjustment strap 21 and the fourth adjustment strap 22 are slidably mounted to the second mounting seat 233, the second adjustment knob 231 is rotatably connected to the second mounting seat 233, the second adjustment gear 232 is mounted to the second adjustment knob 231, the third rack 212 meshes with one side of the second adjustment gear 232, and the fourth rack 222 meshes with the other side of the second adjustment gear 232; it could be understood that the second adjustment knob 231 is used for driving the second adjustment gear 232 to rotate, and the third adjustment strap 21 and the fourth adjustment strap 22 move in the respective length directions by changing the meshing stroke between the second adjustment gear 232 and the third rack 212 and the fourth rack 222, thereby changing the overall length of the second binding strap 2, with high accuracy of adjustment, and further improving the adaptability of the present VR glasses headband.

With reference to FIG. 1, the second binding strap 2 is provided with an overhead cushion pad 25 for contacting the top of a human head, and the overhead cushion pad 25 can cushion the pressure of the second binding strap 2 acting on the top of the human head so as to improve the comfort of the VR glasses headband; specifically, the second binding strap 2 is provided with a mounting bracket 24, the overhead cushion pad 25 is mounted to the mounting bracket 24, and the mounting bracket 24 facilitates the mounting of the overhead cushion pad 25; in the present embodiment, the mounting bracket 24 is rotatably mounted to the second mounting seat 233; in detail, the material of the overhead cushion pad 25 is a flexible material, and the flexible material includes but is not limited to sponge, silica gel, etc. and the material of the overhead cushion pad 25 can be specifically selected according to actual application requirements.

Preferably, in conjunction with FIG. 1, the third adjustment strap 21 is provided with a first snap-fit 211, the first snap-fit 211 snaps onto the fourth adjustment strap 22, the fourth adjustment strap 22 is provided with a second snap-fit 221, and the second snap-fit 221 snaps onto the third adjustment strap 21.

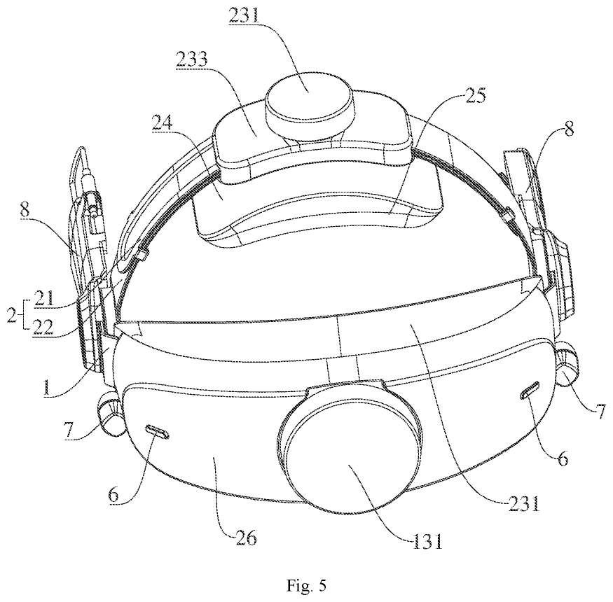

In detail, in conjunction with FIG. 5, the headband body further comprises a housing 26, the earphone cable and the take-up device are both accommodated in the housing 26, the earphone head 7 is exposed to the housing 26 (as shown in FIG. 1), and the take-up device, earphone cable, and earphone head 7 are respectively provided on two sides of the housing 26; in more detail, the housing 26 is mounted to the first binding strap 1.

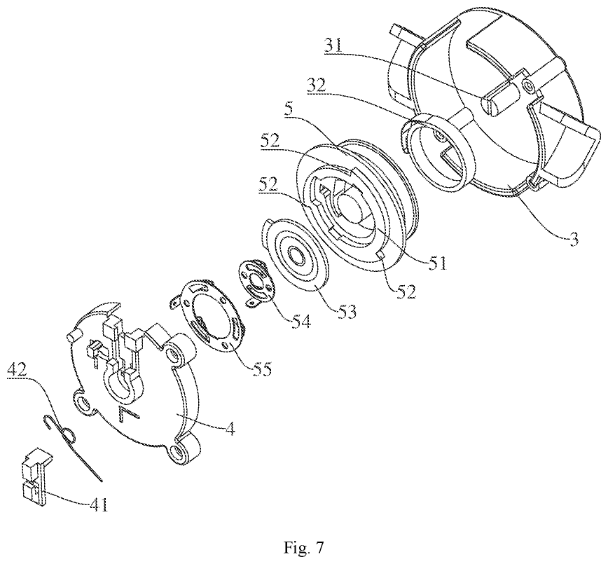

Preferably, in conjunction with FIG. 7, the take-up cable comprises a take-up box, a central post 31, a take-up reel 5, and a spring 32. The central post 31 is mounted in the take-up box, the take-up reel 5 is rotatably mounted to the central post 31, and the earphone cable is wound around the take-up reel 5; one end of the spring 32 is connected to the central post 31, and the other end is connected to the take-up reel 5; the take-up box is convenient for storing the earphone cable; the take-up reel 5 is convenient for winding the earphone cable; when the earphone cable extends out of the take-up box by a certain length, the take-up reel 5 automatically rotates under the action of the spring 32, thereby realizing automatic recovery of the earphone cable, and improving the convenience of using the VR glasses headband; specifically, the take-up box comprises a cover plate 4 and a bottom shell 3 connected to each other; the cover plate 4 and the bottom shell 3 form an accommodating cavity for accommodating the take-up reel 5 after being mounted, and the central post 31 is fixed to the bottom shell 3.

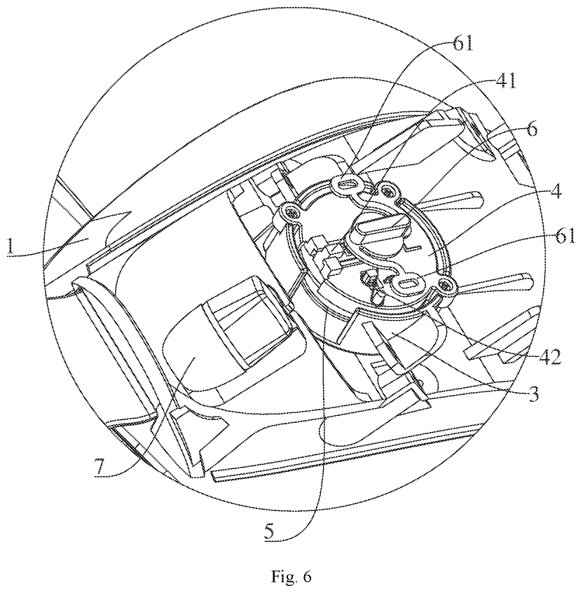

In conjunction with FIGS. 6 and 7, the take-up box is further provided with a non-return structure connected to the take-up reel 5. The non-return structure is used for limiting the rotation of the take-up reel 5, and the non-return structure can limit the automatic rotation of the take-up reel 5, so as to ensure that the earphone is not pulled during use, facilitating the improvement of user experience; specifically, the take-up reel 5 is provided with a limiting portion 51, the limiting portion 51 is provided with multiple limiting grooves 52 evenly spaced along the central axis of the central post 31, the non-return structure comprises a limiting snap-fit 41 slidably mounted to the take-up box, the limiting snap-fit 41 abuts against the limiting portion 51 and is used for, with the limiting groove 52, limiting the rotation of the take-up reel 5, and the rotation of the take-up reel 5 can be effectively limited by the limiting snap-fit 41 cooperating with the limiting groove 52; when the earphone cable needs to be recovered, only the limiting snap-fit 41 needs to be swiped for sliding so as to enable the limiting snap-fit 41 to disengage from the limiting groove 52 so as to realize automatic recovery of the earphone cable, further improving the convenience of using the VR glasses headband; in detail, the non-return structure further comprises an elastic member 42 mounted to the take-up box and connected to the limiting snap-fit 41. The elastic member 42 is used for supporting the limiting snap-fit 41 in the limiting groove 52, and the elastic member 42 facilitates supporting the limiting snap-fit 41 in the limiting groove 52, ensuring that the limiting snap-fit 41 can effectively limit the rotation of the take-up reel 5, and facilitating the improvement of structural stability.

Preferably, in conjunction with FIGS. 5 and 6, the VR glasses headband further comprises a take-up button 6 mounted to the headband body, and the take-up button 6 abuts against the limiting snap-fit 41; when the take-up button 6 is pressed, the limiting snap-fit 41 is disengaged from the limiting groove 52; specifically, the take-up button 6 is mounted to the housing 26 and is exposed to the housing 26, the take-up button 6 is provided with a first wedge-shaped portion, one end of the limiting snap-fit 41 close to the central post 31 is provided with a second wedge-shaped portion which is in contact with the first wedge-shaped portion, and the take-up button 6 facilitates pushing the limiting snap-fit 41 away from the limiting groove 52 such that a user can realize automatic recovery of the earphone cable only by pressing the take-up button 6, further improving the convenience of using the VR glasses headband; more specifically, two opposite sides of the take-up button 6 are respectively provided with a mounting elastic piece 61, the mounting elastic piece 61 is connected to the headband body, the mounting elastic piece 61 facilitates mounting the take-up button 6 to the headband body, and the mounting elastic piece 61 can al so provide a rebound force to the take-up button 6 such that when a user releases the take-up button 6, the take-up button 6 can automatically rebound under the action of the mounting elastic piece 61, further improving the convenience of using the VR glasses headband.

In the present embodiment, the take-up reel 5 is further provided with a circuit board 53, the circuit board 53 is electrically connected to the earphone cable, and the circuit board 53 facilitates the electrical connection with the earphone cable, and ensures the stability of the power amplifier of the earphone head 7; specifically, the take-up box is further provided with a conductive elastic piece electrically connected to the glasses body, and the conductive elastic piece abuts against the circuit board 53 and is electrically connected to the circuit board 53; in detail, the conductive elastic piece comprises a positive pole elastic piece 54 connected to the positive pole of the power supply of the glasses body, and a negative pole elastic piece 55 electrically connected to the negative pole of the power supply of the glasses body; when the take-up reel 5 rotates, the conductive elastic piece does not rotate along with the circuit board 53, avoiding the phenomenon of conductive wire winding between the conductive elastic piece and the glasses body, and ensuring the stability of the functional performance of the VR glasses headband.

With reference to FIGS. 5, 8, and 9, two ends of the first binding strap 1 are respectively provided with a rotary ring 15, two ends of the second binding strap 2 are respectively provided with a rotary convex shaft 27, and the rotary ring 15 is rotatably mounted to the rotary convex shaft 27 and is arranged around the rotary convex shaft 27; the VR glasses headband further comprises a mounting structure 8, one end of the mounting structure 8 is rotatably connected to the rotary convex shaft 27, and the other end of the mounting structure 8 is used for mounting the glasses body; specifically, the inner side of the rotary ring 15 is provided with multiple first limiting locking grooves 151 distributed at uniform intervals, the outer side of the rotary convex shaft 27 is provided with a first limiting emboss 271 which cooperates with the first limiting locking groove 151, and the first limiting emboss 271 cooperates with the first limiting locking grooves 151 at different positions in a clamping manner so that the adjustment of a fixed angle can be performed between the first binding strap and the second binding strap; more specifically, the number of the first limiting embosses 271 is three, and the three first limiting embosses 271 are evenly distributed around the axis of the rotary convex shaft 27; the number of the first limiting locking grooves 151 is nine, three of the first limiting locking grooves 151 are in a group, and each group of the first limiting locking grooves 151 is respectively arranged corresponding to one of the first limiting embosses 271; in detail, the rotary ring 15 is further provided with a second limiting locking groove 152, the second limiting locking groove 152 extends along the circumferential direction of the rotary ring 15, the mounting structure 8 is provided with a second limiting emboss 81 slidably connected to the second limiting locking groove 152, and the rotation angle between the mounting structure 8 and the second binding strap is limited by the cooperation of the second limiting emboss 81 and the second limiting locking groove 152.

In summary, the VR glasses headband provided by the present application has the feature of good wearing comfort. The first adjustment structure is provided to adjust the length of the first binding strap, and the second adjustment structure is provided to adjust the length of the second binding strap, so as to adapt to the wearing requirements of people with different head sizes; the second binding strap is provided to be rotatably mounted to the first binding strap, so as to adapt to the wearing requirements of people with different head shapes, thus greatly improving comfort; the earphone head is mounted to the take-up cable via the earphone cable, and the take-up cable realizes the expansion and contraction of the earphone cable, so as to facilitate the storage and use of the earphone head; the take-up cable is arranged on the headband body, so as to reduce the load of the glasses body, ease the load feeling of the eyes when the user wears it, and further improve the wearing comfort.

The above descriptions are only embodiments of the present application, and are not intended to limit the scope of the present application. Any equivalent transformations made by using the contents of the description and drawings of the present application, or directly or indirectly applied in related technical fields, are similarly included in the scope of the present application.

What is claimed is:

1. A Virtual Reality (VR) glasses headband comprising a headband body, wherein the headband body comprises a first binding strap and a second binding strap, the first binding strap is used to abut against a back side of a head of a human body, the second binding strap is used to abut against a top of the head of a human body, the second binding strap is rotatably connected to the first binding strap, the first binding strap is provided with a first adjustment structure for adjusting a length of the first binding strap, and the second binding strap is provided with a second adjustment structure for adjusting the length of the second binding strap.

2. The VR glasses headband of claim 1, wherein the second binding strap is provided with an overhead cushion pad for contact with the top of a human head.

3. The VR glasses headband of claim 2, wherein the second binding strap is provided with a mounting bracket to which the overhead cushion pad is mounted.

4. The VR glasses headband of claim 2, wherein a material of the overhead cushion pad is a flexible material.

5. The VR glasses headband of claim 1, wherein the first binding strap comprises a first adjustment strap and a second adjustment strap rotatably connected to the second binding strap respectively, the first adjustment strap is provided with a first rack extending along a length direction thereof, the second adjustment strap is provided with a second rack extending along the length direction thereof, the first adjustment structure comprises a first mounting seat, a first adjustment gear, and a first adjustment knob, the first adjustment strap and the second adjustment strap are slidably mounted to the first mounting seat, the first adjustment knob is rotatably connected to the first mounting seat, the first adjustment gear is mounted to the first adjustment knob, the first rack meshes with one side of the first adjustment gear, and the second rack meshes with the other side of the first adjustment gear.

6. The VR glasses headband of claim 1, wherein the second binding strap comprises a third adjustment strap and a fourth adjustment strap rotatably connected to the first binding strap respectively, the third adjustment strap is provided with a third rack extending along a length direction thereof, the fourth adjustment strap is provided with a fourth rack extending along the length direction thereof, the second adjustment structure comprises a second mounting seat, a second adjustment gear, and a second adjustment knob, the third adjustment strap and the fourth adjustment strap are slidably mounted to the second mounting seat, the second adjustment knob is rotatably connected to the second mounting seat, the second adjustment gear is mounted to the second adjustment knob, the third rack meshes with one side of the second adjustment gear, and the fourth rack meshes with the other side of the second adjustment gear.

7. The VR glasses headband of claim 6, wherein the third adjustment strap is provided with a first snap-fit, the first snap-fit snapping onto the fourth adjustment strap.

8. The VR glasses headband of claim 6, wherein the fourth adjustment strap is provided with a second snap-fit, the second snap-fit snapping onto the third adjustment strap.

9. The VR glasses headband of claim 1, wherein the first binding strap is provided with a rear pillow cushion pad for contact with the back side of the head of a human body.

10. The VR glasses headband of claim 1, further comprising a glasses body, an earphone head, an earphone cable, and a take-up cable, wherein the glasses body is connected to the headband body, the earphone head is connected to one end of the earphone cable, the earphone cable is wound around the take-up cable, the other end of the earphone cable is electrically connected to the glasses body, and the take-up cable is mounted to the headband body.

11. The VR glasses headband of claim 10, wherein the take-up cable comprises a take-up box, a central post, a take-up reel, and a spring, wherein the central post is mounted in the take-up box, the take-up reel is rotatably mounted to the central post, and the earphone cable is wound around the take-up reel; one end of the spring is connected to the central post, and the other end is connected to the take-up reel.

12. The VR glasses headband of claim 11, wherein the take-up box is further provided with a non-return structure connected to the take-up reel for limiting a rotation of the take-up reel.

13. The VR glasses headband of claim 12, wherein the take-up reel is provided with a limiting portion, the limiting portion is provided with multiple limiting grooves distributed evenly spaced along a central axis of the central post, and the non-return structure comprises a limiting snap-fit slidably mounted to the take-up box, the limiting snap-fit abutting against the limiting portion for, with the limiting groove, limiting the rotation of the take-up reel.

14. The VR glasses headband of claim 13, wherein the non-return structure further comprises an elastic member mounted to the take-up box and connected to the limiting snap-fit, the elastic member is used for supporting the limiting snap-fit within the limiting groove.

15. The VR glasses headband of claim 13, further comprising a take-up button mounted to the headband body, the take-up button abutting against the limiting snap-fit, and the limiting snap-fit disengaging from the limiting groove when the take-up button is pressed.

16. The VR glasses headband of claim 15, wherein the take-up button is provided with a first wedge-shaped portion, and one end of the limiting snap-fit close to the central post is provided with a second wedge-shaped portion that abuts against the first wedge-shaped portion.

17. The VR glasses headband of claim 15, wherein two opposite sides of the take-up button are provided with mounting elastic pieces respectively, the mounting elastic pieces are connected to the headband body.

18. The VR glasses headband of claim 11, wherein the take-up reel is further provided with a circuit board, the circuit board is electrically connected to the earphone cable.

19. The VR glasses headband of claim 18, wherein the take-up box is further provided with a conductive elastic piece electrically connected to the glasses body, the conductive elastic piece abutting against the circuit board and is electrically connected to the circuit board.
